(19) United States
(12) Patent Application Publication
(10) Pub. No.: US 2021/0230931 A1
(43) Pub. Date: Jul. 29, 2021

(54) VERSATILE HYBRID FENESTRATION SYSTEM

(71) Applicant: Sierra Pacific Industries, Anderson, CA (US)

(72) Inventor: Brandon Rausch, Anderson, CA (US)

(21) Appl. No.: 17/159,675

(22) Filed: Jan. 27, 2021

Related U.S. Application Data
(60) Provisional application No. 62/966,201, filed on Jan. 27, 2020.

(51) Int. Cl. E06B 3/58; E06B 3/62

(52) U.S. Cl. CPC E06B 3/5828; E06B 3/10; E06B 3/62; E06B 3/5892

(57) ABSTRACT

Fenestration assemblies and methods for making fenestration assemblies are discussed herein. In one aspect the fenestration assembly can include a base frame assembly, a support frame assembly, a clipping assembly and a window pane. The base frame assembly is connected to a plurality of other base frame assembly members which can form a frame. The base frame assembly members each have a clipping assembly which attaches a piece of exterior cladding to the base frame assembly. The cladding member and the clipping member also assist in securing the window pane. In some examples the exterior cladding protects the base frame assembly. Many different styles of exterior cladding can be fitted to the clipping assembly

### CROSS-REFERENCE TO RELATED APPLICATIONS

This application claims priority to U.S. Provisional Application Ser. No. 62/966,201, filed Jan. 27, 2020, the entirety of which is incorporated herein by reference.

### TECHNICAL FIELD

This disclosure relates generally to fenestration assemblies and methods of constructing fenestration assemblies.

### BACKGROUND

Fenestration assemblies have historically been fabricated with a structural base frame, a sash frame that holds one of more glass panes, an exterior cladding frame, and various trim pieces. The base frame is the portion of the window assembly which is attached to the structure of the building. The exterior cladding frame is the exterior portion of the window assembly that defines the exterior aesthetic appearance of the window assembly and provides for window protection. Some window assemblies require that the base frame be uniquely designed to match a particular exterior cladding frame. Some window assemblies require that the base frame be uniquely designed to match a particular exterior cladding frame. Some window assemblies require that the exterior cladding frame be connected to the building structure and to the base frame. Improvements are desired.

### SUMMARY

Fenestration assemblies and methods for making fenestration assemblies are disclosed herein.

In one example, a fenestration assembly can include a window pane, a base frame assembly defining an opening receiving the window pane, the base frame assembly defining an exterior side and an interior side, a clip assembly connected to the base frame assembly, the clip assembly securing the window pane within the base frame assembly, and an exterior cladding assembly secured to both the base frame assembly and the clip assembly.

In one example, a fenestration assembly can include a window pane, a base frame assembly defining an opening receiving the window pane, the base frame assembly defining an exterior side and an interior side, a clip assembly connected to the base frame assembly via fasteners, the clip assembly securing the window pane within the base frame assembly, and an exterior cladding assembly secured to both the base frame assembly and the clip assembly with a fastenerless connection In some examples, the base frame assembly is formed from a wood material.

In some examples, the exterior cladding assembly formed from a metal material.

In some examples, the clip assembly is made of a polymeric material.

In some examples, the exterior cladding assembly and clip assembly are formed from extruded members.

In some examples, the fenestration assembly is a door assembly.

In some examples, the exterior cladding assembly includes one or more stand-off members extending to and contacting the base frame assembly to create an interior air space between the exterior cladding assembly and the base frame assembly.

In some examples, the base frame members define a channel into which a portion of the exterior cladding assembly is received.

In some examples, a separate clip secures a connection between the clip assembly and the exterior cladding assembly.

In some examples, the clip assembly is secured to the base frame assembly via fasteners.

In some examples, the fasteners are staples.

In one example the fenestration assembly can include a window pane, a base frame assembly defining an opening receiving the window pane, the base frame assembly defining an exterior side and an interior side, an exterior cladding assembly secured to the base frame, the exterior cladding assembly retaining the window pane within the opening, and a clip assembly connected to the base frame assembly and to the exterior cladding assembly to secure the exterior cladding assembly to the base frame assembly, a portion of the clip assembly being located between the exterior cladding assembly and the window pane.

In a different example a fenestration assembly comprises a window pane, a base frame assembly defines an opening receiving the window pane, the base frame assembly defines an exterior and an interior side. An exterior cladding assembly retains the window pane within the opening, and a clip assembly connected to the base frame assembly with a first wood-metal interlocking connection and a second wood-metal interlocking connection.

A variety of additional aspects will be set forth in the description that follows. The aspects can relate to individual features and to combinations of features. It is to be understood that both the forgoing general description and the following detailed description are exemplary and explanatory only and are not restrictive of the broad inventive concepts upon which the examples disclosed herein are based.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 is a perspective view of a fenestration assembly.

FIG. 2 is a front view of the fenestration assembly of FIG. 1.

FIG. 2A is a front view of the fenestration assembly of FIG. 1, with the exterior cladding removed.

FIG. 3 is a bottom view of the fenestration assembly of FIG. 1.

FIG. 4 is an enlarged partial view of the fenestration assembly of FIG. 1, as indicated at ‘4’ in FIG. 1.

FIG. 5 is a perspective interior view of the fenestration assembly of FIG. 1.

FIG. 6 is enlarged partial view of the interior view of the fenestration assembly of FIG. 5, as indicated at ‘6’ in FIG. 5.

FIG. 7 is a perspective view of a portion of the exterior cladding assembly of FIG. 1.

FIG. 8 is a bottom view of the exterior cladding assembly of FIG. 7.

FIG. 9 is a cross-sectional perspective view of a portion of the clipping assembly from FIG. 2A.

FIG. 10 is an end view of the clipping assembly from FIG. 2 A.

FIG. 11 is a cross-sectional view of the fenestration assembly of FIG. 1, taken along the line 11-11 in FIG. 2.

FIG. 12 is a cross-sectional view of a portion of the fenestration assembly of FIG. 1 highlighting the cladding member as well as connection points between the base members.

FIG. 13 is a perspective view of a portion of the base frame member from the fenestration assembly of FIG. 1.

FIG. 14 is a side view of a portion of the base frame member from the fenestration assembly of FIG. 1.

FIG. 15 is an end view of the base frame member from FIG. 1.

FIG. 16 is a cross-sectional view of a portion of the fenestration assembly of FIG. 1, showing an alternative configuration for the base frame, clip, and cladding members.

FIG. 17 is a perspective view of a portion of the exterior cladding member of the assembly of FIG. 16.

FIG. 18 is an end view of the exterior cladding assembly of FIG. 17.

FIG. 19 is a perspective view of a portion of the clipping member of the assembly of FIG. 16.

FIG. 20 is an end view of the clipping member shown at FIG. 19.

FIG. 21 is an end view of the base frame member of the assembly shown at FIG. 16.

FIG. 22 is a cross-sectional end view of the fenestration assembly of FIG. 16, showing the presence of a clip member.

FIG. 23 is a partial perspective view of the fenestration assembly of FIG. 16, showing the clip member in an installed position.

FIG. 24 is a partial perspective view of the fenestration assembly of FIG. 16, showing the clip member in an installed position.

### DETAILED DESCRIPTION

Various examples will be described in detail with reference to the drawings, wherein like reference numerals represent like parts and assemblies throughout the several views. Reference to various examples does not limit the scope of the claims attached hereto. Additionally, any examples set forth in this specification are not intended to be limiting and merely set forth some of the many possible examples for the appended claims. Referring to the drawings wherein like reference numbers correspond to like or similar components throughout the several figures.

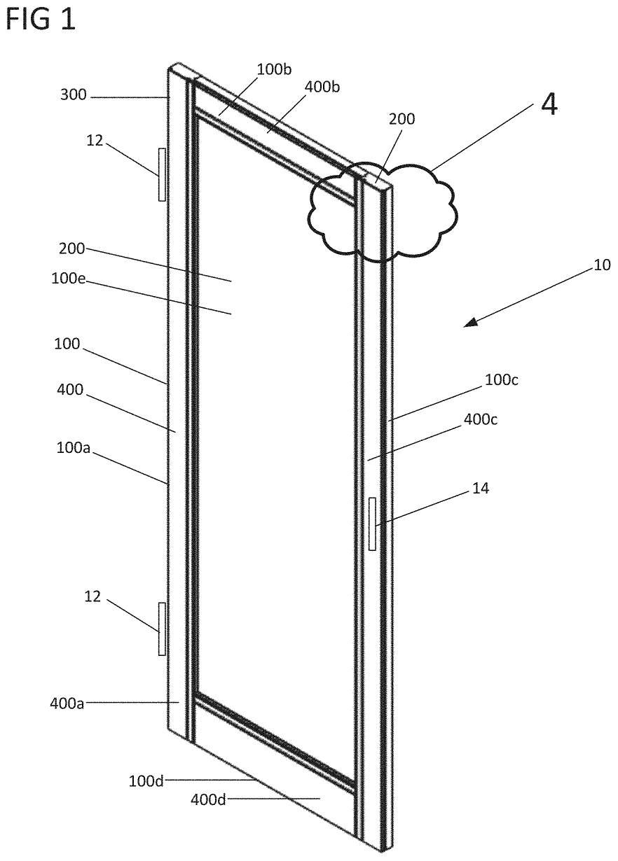

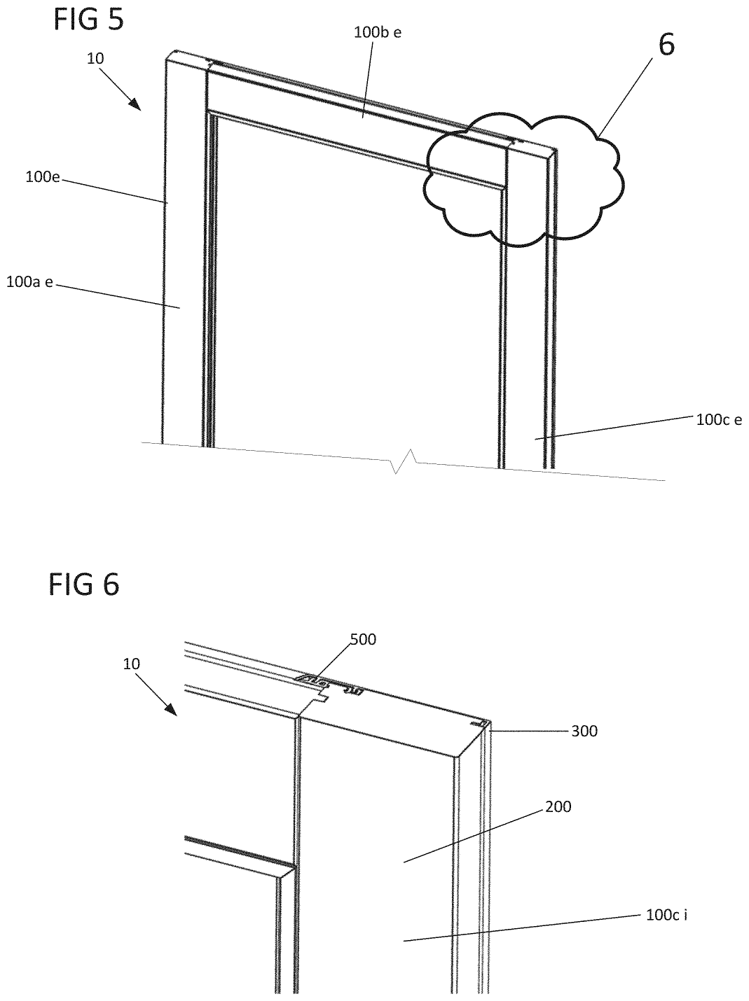

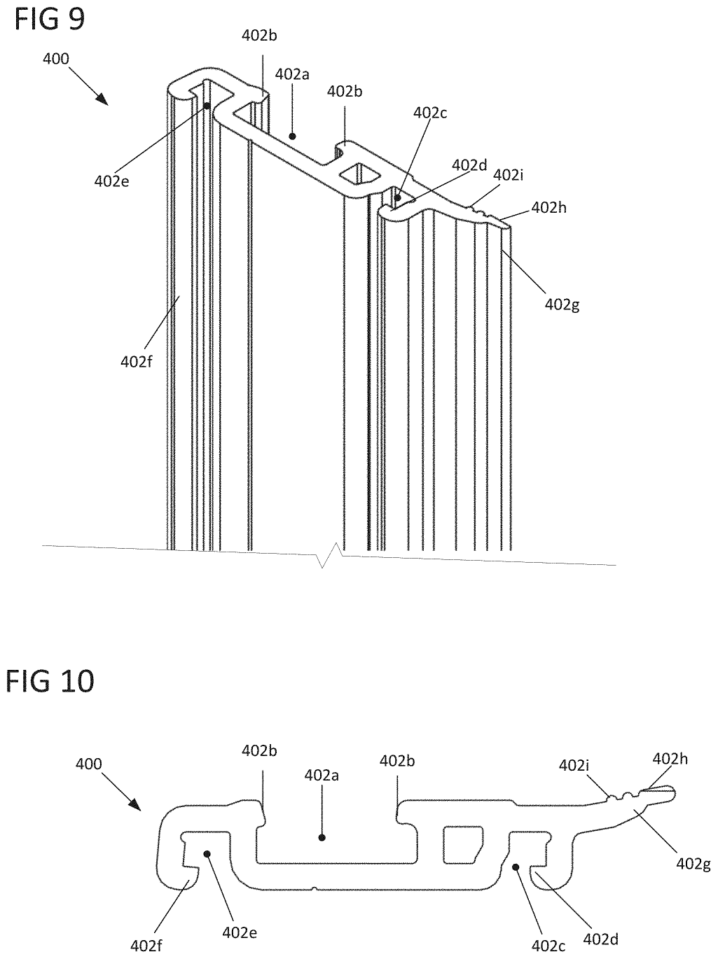

In the embodiment illustrated in FIGS. 1-15, a fenestration assembly 10 is presented. The fenestration assembly 10 may be, for example, a window assembly or a door assembly. In the particular example shown, the fenestration assembly 10 is a patio door 10 retaining a single window pane 200, and including one or more hinges 12 for mounting the door 10 within a frame or opening and including a lock/handle 14 for operating the door 10. Other configurations are possible without departing from the concepts presented herein. In one aspect, the window pane 200 is secured within an opening 100e, defined by a base frame assembly 100, on one side by an interior trim assembly 300 and on an opposite side by a clip assembly 400 and an exterior cladding assembly 500.

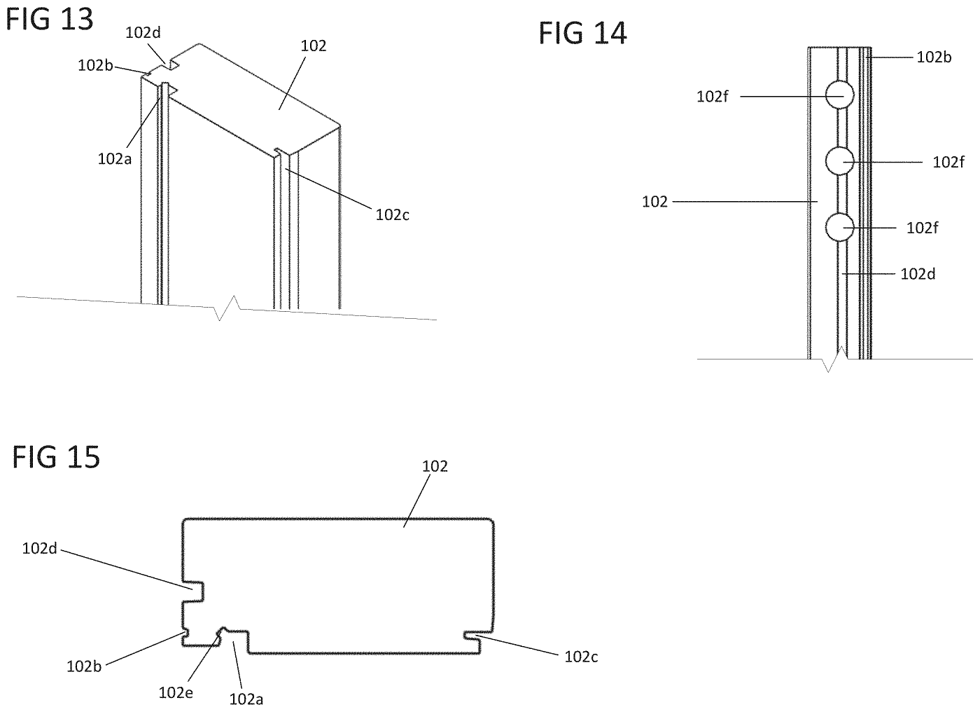

Referring to FIGS. 1-6 and 11-15, the fenestration assembly 10 is shown as including a base frame assembly 100 formed from a plurality of base frame members 100a, 100b, 100c, 100d. In the example shown, the base frame members 100a-100d are produced from the same stock material and have the same general cross-sectional shape, as further illustrated at FIGS. 13-15. In the example shown, the base frame members 100a-100d are arranged to form a rectangular frame assembly defining a central opening 100e receiving a window pane 200. Other arrangements are possible including more or fewer base frame members, multiple openings, multiple window panes, and/or other frame shapes.

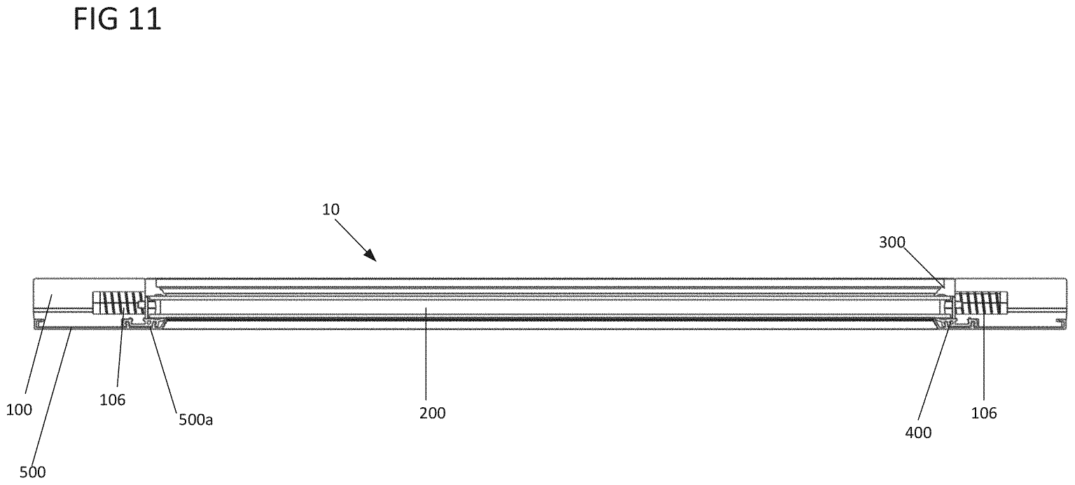

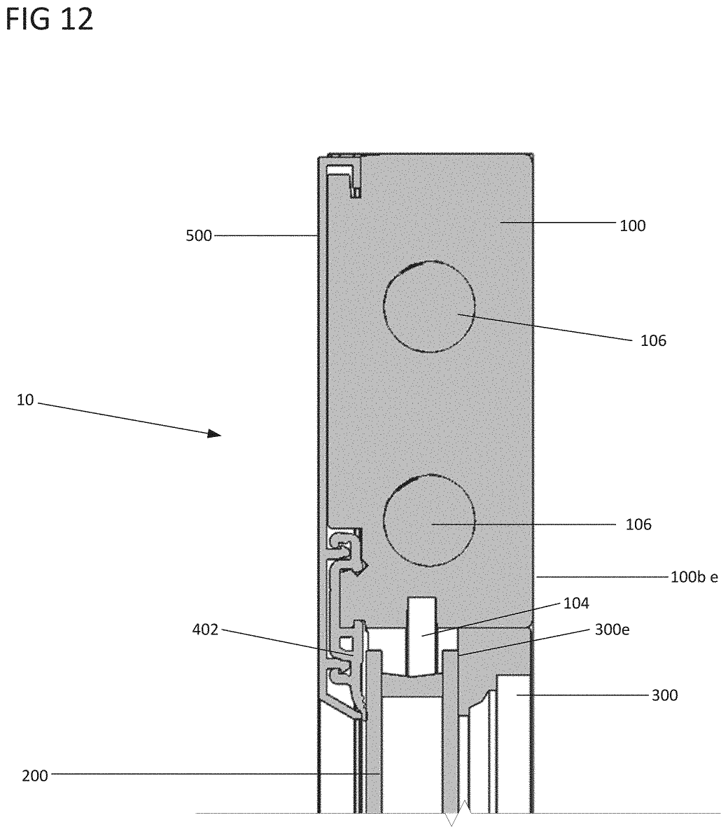

In one aspect, and as most easily seen at FIGS. 13-15, each base frame member 100 has a main body 102, which can be formed from a wood material, with various features. For example, the main body 102 is shown as including a kerfs or recesses 102a, 102b, 102c, and 102d for receiving various components of the assembly 10, as is discussed in further detail below. Each of the kerfs or recesses 102a-102d is generally rectangular in shape and cut orthogonally into one of the faces of the main body 102, although the recess 102a is provided with a further recess 102e at one corner and extending at an oblique angle to the main portion of the recess 102a. The recess 102d is oriented to face the outer edge of the window pane 200 and to receive a gasket 104, as most easily seen at FIG. 12, such that a weather proof or resistant seal can be formed between the base frame assembly 100 and the window pane 200. The functions of the other kerfs or recesses 102a-102c are explained in further detail below. In one aspect, the main body 102 is also provided with a plurality of recesses 102f such that the base members 100a-100d can be joined together with dowels 106 received within the recesses 102f, as is illustrated at FIGS. 11-12 and 14. Alternatively, the base frame members 100a-100d can be joined together to form a frame by other means without departing from the concepts presented herein. As should be appreciated, the main body 102 of each base frame member 102a-102d is uniform with the exception of the location and orientation of the recesses 102f.

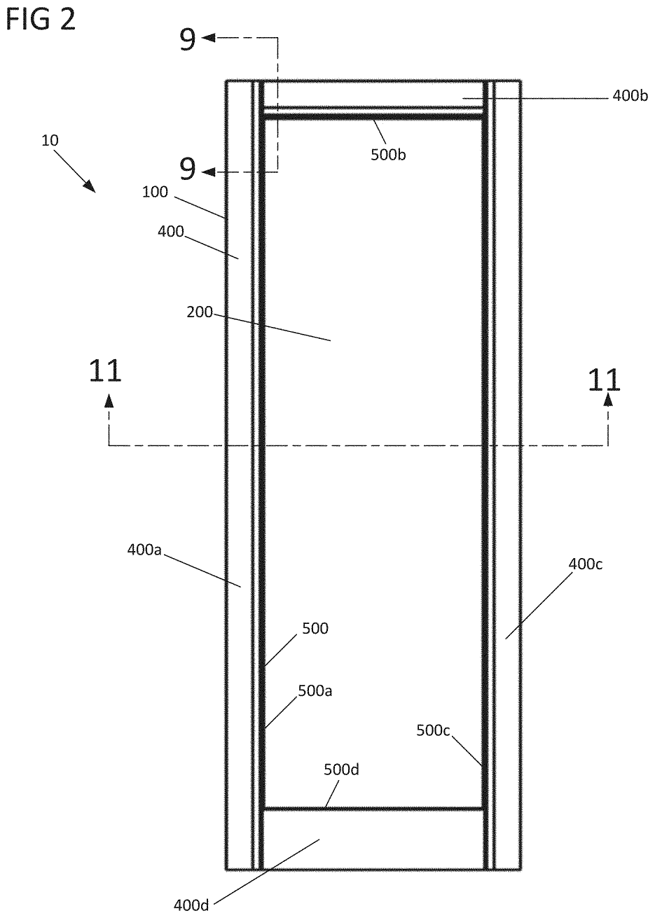

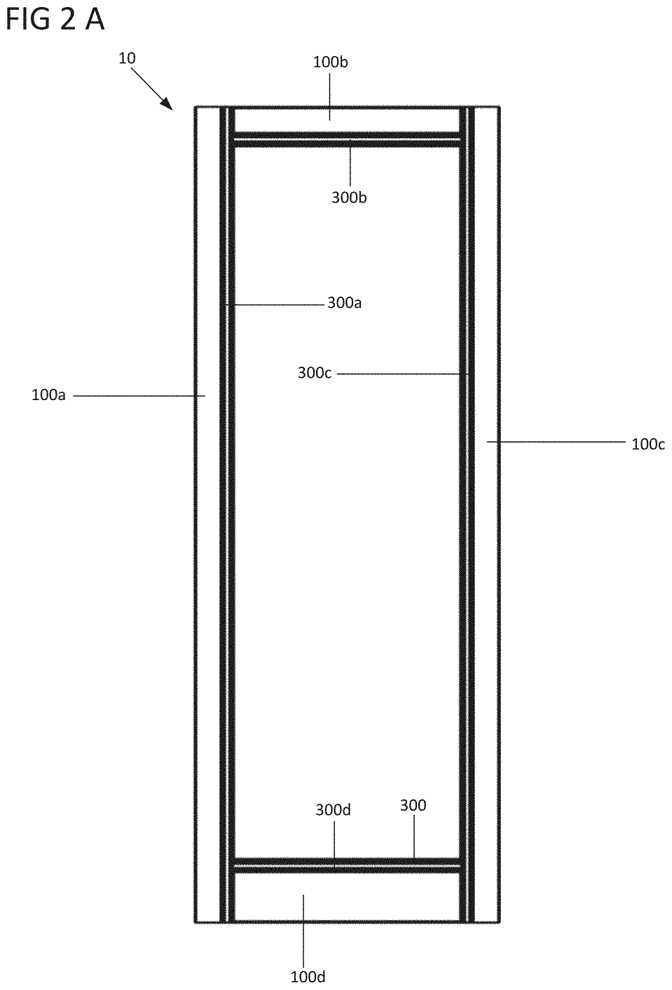

As shown, the trim assembly includes trim members 300a, 300b, 300c, 300d. In the example shown, the trim members 300a-300d are produced from the same stock material and have the same general cross-sectional shape, as further illustrated at FIGS. 2A, 11, and 12. The trim members 300a-300d are respectively attached to the base frame members 100a-100d about the perimeter of the openings 100e such that each of the trim members 300a-300d presents a face 300e facing the window pane 200. The face 300e may either be in direct contact with the window pane 200 or can be separated from the window pane 200 by a gasket or other type of material, such as a silicone-based material. The trim members 300a-300d can be attached to the base frame members 100a-100d by conventional means, for example, fasteners such as nails or screws or by an adhesive. A snap-fit construction could also be provided. Also, the trim members 300a-300b may be attached to each other, for example at the corners, or may form a frame by virtue of being independently attached to the base frame members 100a-100d.

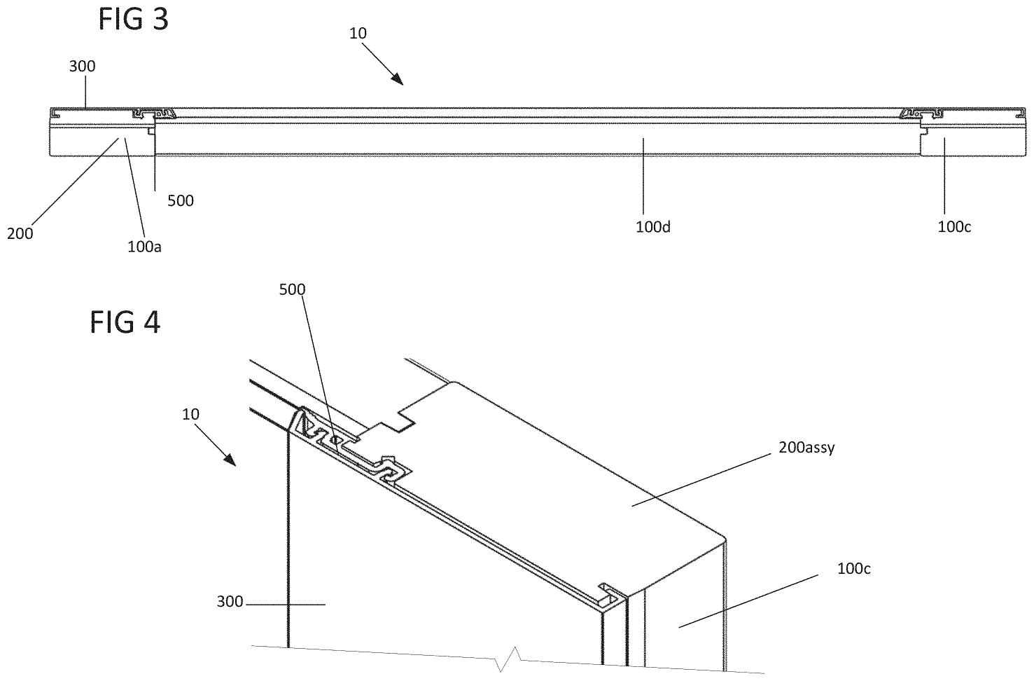

Referring to FIGS. 3-4, 6, and 9-12, the clip assembly 400 is shown in further detail. As described in more detail below, the clip assembly 400 simultaneously performs the functions of providing a surface for contacting the window pane 200 opposite the interior trim assembly 300 and of securing the cladding assembly 500 to the base frame assembly 100. As shown, the clip assembly 400 includes clip members 400a, 400b, 400c, 400d. In the example shown, the clip members 400a-400d are produced from the same stock material and have the same general cross-sectional shape. The clip members 400a-400d are respectively attached to the base frame members 100a-100d. In one aspect, each clip member 400a-400d is a unitarily formed component including a main body 402 with various features. For example, the main body 402 can include a first channel 402a partially defined by a pair of lip or catch members 402b. The main body 402 can further include a second channel 402c partially defined by a lip or catch member 402d. The main body 402 can also include a third channel 402e partially defined by a lip or catch member 402f. The main body 402 can further include an extension member 402g defining a face 402h for contacting the window pane 200. The extension member 402h can be provided with ribs 402i or other similar features to improve sealing and gripping with the window pane 200. The clipping assembly 300 can be made from a polymeric material or a different material. The clipping assembly 300 can also be an extruded member. The clip members 400a-400b may be attached to each other, for example at the corners, or may form a frame by virtue of being independently attached to the base frame members 400a-400d.

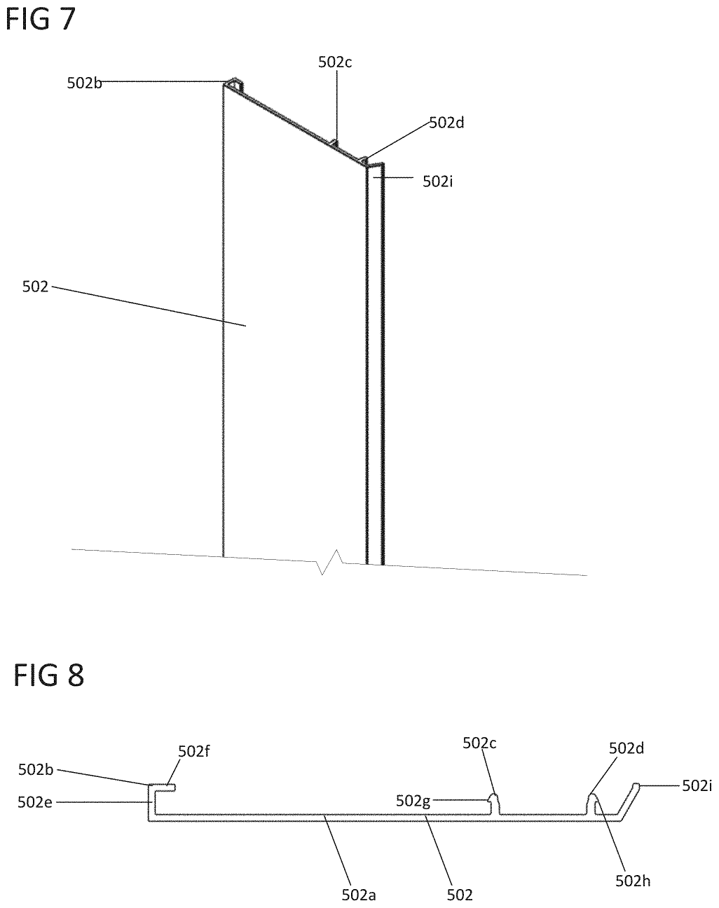

With reference to FIGS. 1 and 3-8, the cladding assembly 500 is shown in further detail. The cladding assembly 500, which can be formed from a metal material such as aluminum, can provide a weather-resistant and improved aesthetic appearance to the exterior of the assembly 10. Accordingly, the assembly 10 can be provided with a wood interior finish and a metal exterior finish. As shown, the cladding assembly 500 includes cladding members 500a, 500b, 500c, 500d. In the example shown, the cladding members 500a-500d are produced from the same stock material and have the same general cross-sectional shape. The cladding members 500a-500d are respectively attached to the base frame members 100a-100d and to the clip members 400a-400d. In one aspect, each cladding member 500a-500d is a unitarily formed component with a main body 502 having various features. For example, and as most easily viewed at FIGS. 7 and 8, the main body 502 can include a main exterior surface 502a from which clip portions 502b, 502c, 502d extend. In the example shown, the clip portion 502b has an L-shape with a first portion 502e and a second portion 502f. The clip portions 502c and 502d are provided with catch or latch portions 502g, 502h. The main body 502 is also shown as including an extension portion 502i which extends at an oblique angle to the main exterior surface 502a. The function of these features is described in further detail below.

As most easily seen at FIG. 12, and as previously described, the window pane 200 is sandwiched and secured between the interior trim assembly 300 and the clip assembly 400/cladding assembly 500. To assemble the assembly 10, the frame assembly 100 is constructed and the interior trim assembly 300 can be secured to the frame assembly 100, either as a whole frame or in separate pieces as previously described. The gasket 104 and the window pane 200 can then be installed within the opening 100e with one side of the window pane 200 against the interior face 300e of the interior trim assembly 300. Subsequently, the clip members 400a-400d can be installed onto the base frame members 100a-100d. To secure the clip members 400a-400d, the main body 402 of each clip member can be slid or pressed onto the main body 102 of each of the base frame member 100a-100d such that the catch members 102b are received into the recesses 102e and 102b of the main body 102. In this position, the extension member 402b of the clip member main body 402 extends towards the window pane 200 such that the extension member face 402h and ribs 402i are adjacent the window pane 200. Once the clip members 400a-400d are attached to the base frame members 100a-100d, the cladding members 500a-500d can be joined to the base frame members 100a-100d and to the clip members 400a-400d. This step can be performed by first inserting the portion 502f of the clip member 502b into the kerf or groove 102d on the base frame member main body 102. The cladding member main body 502 can then be rotated such that the extensions 502c and 502d are received into the recesses 402d and 402e of the clip member main body 402, wherein the catch members 502g, 502h respectively engage with the catch members 402d, 402f In this position, the cladding members 500a-500d are fully secured to the base frame members 100a-100d and to the clip members 400a-400d. Furthermore, this securement results in the extension members 502i of the cladding member main bodies 502 being forced, and to some extent deflecting, against the extension members 402g of the clip member main bodies 402 such that the extension members 402g are compressed against the window pane 200 to provide a tight and securement of the window pane 200. As the clip member main body 402 is formed of a polymeric material, the contact between the clip member main body and the window pane 200 will not damage the main body.

Due to the unique nature of the clipping assembly 500, the cladding assembly 300, and the base frame assembly 100, the cladding assembly can easily be replaced if desired of switched to a variety of different materials. The fenestration assembly 10 is versatile and its components can be configured to window, door, or other fenestration type assembly. The base frame assembly 100 can be configured to receive multiple window panes or just a single window pane 400 as shown in the drawings.

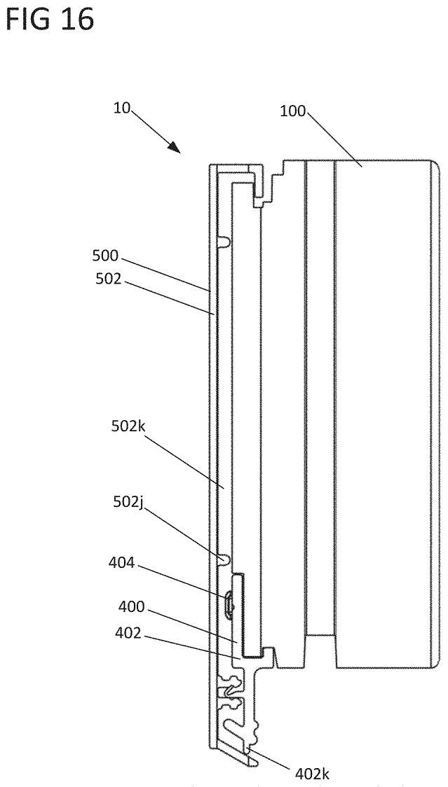

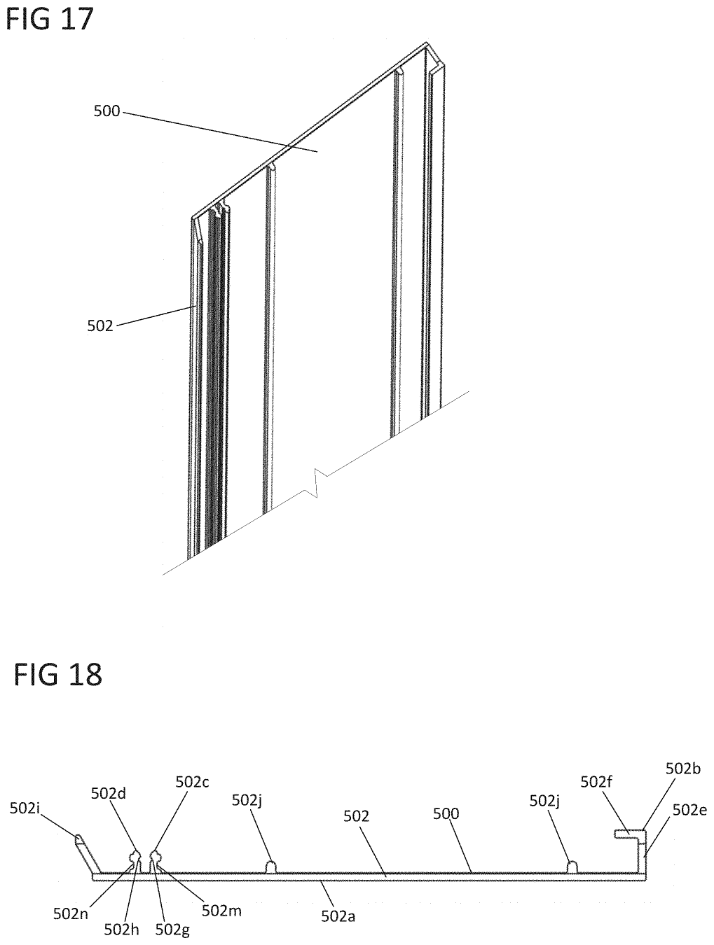

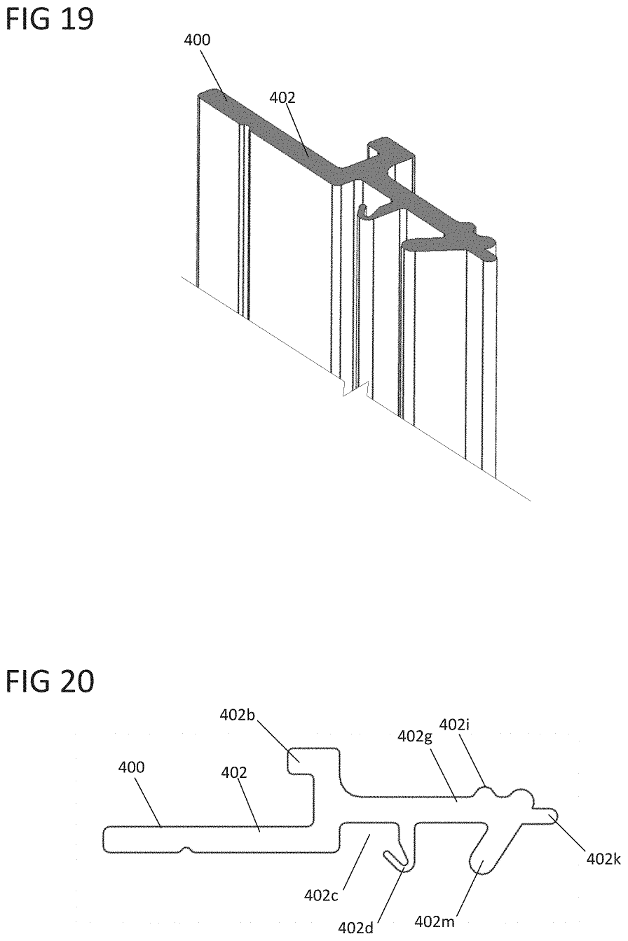

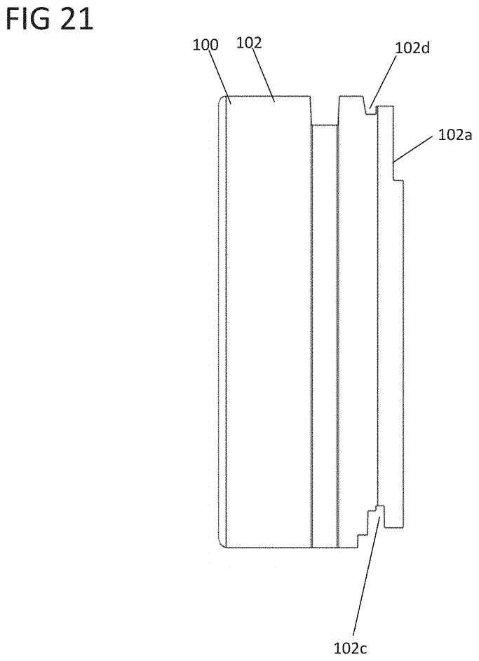

Referring to FIGS. 16 to 24, an alternative design for the members of the base frame assembly 100, clip assembly 400, and exterior cladding assembly 500, usable with the fenestration assembly 10, is presented. The example shown at FIGS. 16 to 24 shares many features in common with the example shown at FIGS. 1 to 15. Accordingly, the previous description above for FIGS. 1 to 15 is therefore generally applicable for the example shown at FIGS. 16 to 24, and need not be repeated here. The description for the example shown at FIGS. 16 to 24 provided here will therefore be focused on the differences between the embodiments.

In one aspect, the example shown at FIGS. 16 to 24 is different from the previous example in that the members of the clip assembly 400 are secured to the members of the base frame assembly 100 via a fasteners 402, for example by staples, rather than being attached by a snap-fit connection. In another aspect, the cladding member main body 502 is provided with stand-off structures 502j which create an air gap or space 502k between the interior side of the main body 502 and the base member 100. This configuration enhances thermal insulation properties of the assembly. Such an approach also enables for the wood profiles of the base frame members 100 to be kept at the same thickness across different widths that may be provided for various window sizes. In the example shown, two stand-off structures 502j are provided. However, none or more may be provided, depending upon application.

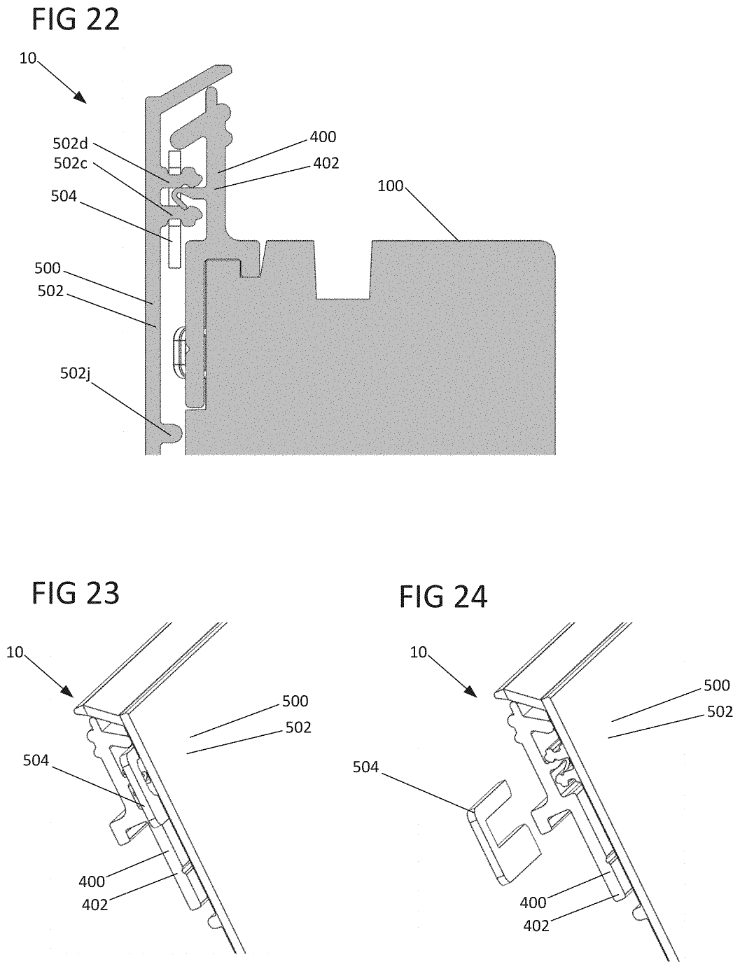

In one aspect, the example shown at FIGS. 16 to 24 is different from the previous example in that the exterior cladding members 500 snap-fit to the clip members 400 with an alternative configuration. In this example, the clip portions 502c and 502d are positioned relatively closer to each other in comparison to the previous example. The clip portions 502c, 502d are also provided with interior facing latch portions 502g, 502h, one of which accepts the catch member 402da single extension member of the clip member 400. In the example shown, the catch member 402d is formed as a deflectable member that initially compresses during installation of the cladding member 500 and then snaps into one of the latch portions 502g, 502h once the cladding member 500 is fully depressed and installed. As can be most easily seen at FIGS. 22 to 24, the snap-fit connection between the cladding member 500 and the clip member 400 can be further secured with a U-shaped clip 504 which slides into grooves or channels 502m, 502n defined by the clip portions 502c, 502d. When the clip 504 is installed, the clip portions 502c, 502d are prevented from deflecting away from each other such that the catch member 402d is prevented from being released from the clip portions 502c, 502d. In one aspect, clips 504 are provided at each end of the cladding members 500. In some examples, the clips 504 are provided with two u-shaped portions and are configured as corner keys that additionally operate to secure the adjacent cladding members 500a-500d together.

In one aspect, the example shown at FIGS. 16 to 24 is different from the previous example in that the clip members 400 are provided with an extension member 402k that extends to the interior side of the cladding member extension portion 502i. The extension member 5402k, which can be a deflectable or flexible member, functions to provide a stop surface such that silicone sealant applied between the window pane 200 and the clip member 400 does not flow into the cavity space 502k between the cladding members 500 and the clip member 400. The clip member 400 can also be provided with an extension member 402m which can provide a stop against the cladding member 500 and/or clip 504 to limit potential deflection of the extension member 402g.

In one aspect, the example shown at FIGS. 16 to 24 is different from the previous example in that the base frame members 102 are provided with an open recess 102a and a modified recess shape 102d for accepting the differently shaped a clip member 400 and fastener 404. With the disclosed configuration, the recess 102a allows for the outer surface of the clip member 400 to be generally flush with the surface of the base member 100, thus maintaining the gap 502k and providing a space for the top of the fasteners 404.

From the forgoing detailed description, it will be evident that modifications and variations can be made in the aspects of the disclosure without departing from the spirit or scope of the aspects. While the best modes for carrying out the many aspects of the present teachings have been described in detail, those familiar with the art to which these teachings relate will recognize various alternative aspects for practicing the present teachings that are within the scope of the appended claims.

We claim:

1. A fenestration assembly comprising:
a) a window pane;
b) a base frame assembly defining an opening receiving the window pane, the base frame assembly defining an exterior side and an interior side;
c) a clip assembly connected to the base frame assembly, the clip assembly securing the window pane within the base frame assembly; and
d) an exterior cladding assembly secured to both the base frame assembly and the clip assembly.

2. The fenestration assembly of claim 1, wherein the base frame assembly is formed from a wood material.

3. The fenestration assembly of claim 1, wherein the exterior cladding assembly formed from a metal material.

4. The fenestration assembly of claim 1, wherein the clip assembly is made of a polymeric material.

5. The fenestration assembly of claim 1, wherein the exterior cladding assembly and clip assembly are formed from extruded members.

6. The fenestration assembly of claim 1, wherein the fenestration assembly is a door assembly.

7. The fenestration assembly of claim 1, wherein the exterior cladding assembly includes one or more stand-off members extending to and contacting the base frame assembly to create an interior air space between the exterior cladding assembly and the base frame assembly.

8. The fenestration assembly of claim 1, wherein the base frame members define a channel into which a portion of the exterior cladding assembly is received.

9. The fenestration assembly of claim 1, further comprising a separate clip securing a connection between the clip assembly and the exterior cladding assembly.

10. The fenestration assembly of claim 1, wherein the clip assembly is secured to the base frame assembly via fasteners.

11. A fenestration assembly comprising:
a) a window pane;
b) a base frame assembly defining an opening receiving the window pane, the base frame assembly defining an exterior side and an interior side;
c) a clip assembly connected to the base frame assembly via fasteners, the clip assembly securing the window pane within the base frame assembly; and
d) an exterior cladding assembly secured to both the base frame assembly and the clip assembly with a fastenerless connection.

12. The fenestration assembly of claim 11, wherein the base frame assembly is formed from a wood material.

13. The fenestration assembly of claim 11, wherein the exterior cladding assembly formed from a metal material.

14. The fenestration assembly of claim 11, wherein the clip assembly is made of a polymeric material.

15. The fenestration assembly of claim 11, wherein the exterior cladding assembly and clip assembly are formed from extruded members.

16. The fenestration assembly of claim 11, wherein the fenestration assembly is a door assembly.

17. The fenestration assembly of claim 11, wherein the exterior cladding assembly includes one or more stand-off members extending to and contacting the base frame assembly to create an interior air space between the exterior cladding assembly and the base frame assembly.

18. The fenestration assembly of claim 11, wherein the base frame members define a channel into which a portion of the exterior cladding assembly is received.

19. The fenestration assembly of claim 11, further comprising a separate clip securing a connection between the clip assembly and the exterior cladding assembly.

20. The fenestration assembly of claim 11, wherein the fasteners are staples.
